(19) United States
(12) Patent Application Publication
(10) Pub. No.: US 2024/0178784 A1
(43) Pub. Date: May 30, 2024

(54) FAULT-TOLERANT CONTROL METHOD FOR OPEN-CIRCUIT FAULT IN ALTERNATING CURRENT MOTOR AND INVERTER THEREOF

(71) Applicant: XPT EDS (Hefei) Co., Ltd., Hefei City (CN)

(72) Inventors: Zekun XIA, Hefei (CN); Kai WANG, Hefei (CN)

(21) Appl. No.: 18/519,170

(22) Filed: Nov. 27, 2023

(30) Foreign Application Priority Data
Nov. 28, 2022 (CN) 202211500663.0

(51) Int. Cl. H02P 29/024; H02P 23/00; H02P 27/06

(52) U.S. Cl. CPC H02P 29/024; H02P 23/0022; H02P 27/06

(57) ABSTRACT

The disclosure relates to the field of motor control, and more specifically, to a fault-tolerant control method and apparatus for an open-circuit fault in an alternating current motor and an inverter thereof, a computer device, and a computer storage medium. The method includes: A: determining, based on fault information of the alternating current motor and the inverter for driving the alternating current motor, a rotor fault position interval corresponding to each fault phase in one or more fault phases; B: establishing a fault-tolerant control constraint model, where the fault-tolerant control constraint model includes an open-circuit fault equation applicable to each fault phase for the corresponding rotor fault position interval; and C: determining, with the fault-tolerant control constraint model as a constraint, a phase current reference value by using a fault-tolerant control algorithm.

### CROSS-REFERENCE TO RELATED APPLICATIONS

This application claims the benefit of and priority to China Patent Application No. 202211500663.0 filed Nov. 28, 2022, the entire disclosure of which is hereby incorporated herein by reference, in its entirety, for all that it teaches and for all purposes.

### TECHNICAL FIELD

The disclosure relates to the field of motor control, and more specifically, to a fault-tolerant control method and apparatus for an open-circuit fault in an alternating current motor and an inverter thereof, a computer device, and a computer storage medium.

### BACKGROUND

For an electric vehicle with a front motor drive and a rear motor drive, when one motor drive system fails, the electric vehicle can still maintain normal operation by means of the other motor drive system. However, this method is not applicable to a single-motor-drive vehicle. To ensure long-term stable operation of the single-motor-drive vehicle in the event of a fault, the motor drive system needs to have a good fault-tolerant capability. Currently, a common strategy for dealing with an open-circuit fault in an alternating current motor and an inverter thereof is to add an auxiliary circuit to implement fault-tolerant control. However, this strategy will increase system costs and complexity, and cannot be directly applied to existing alternating current motor drive system products.

Currently, there are fewer pure software fault-tolerant control strategies for dealing with the open-circuit fault in the alternating current motor and the inverter thereof without changing a hardware circuit structure of the motor and the inverter. In addition, existing pure software fault-tolerant control strategies for a three-phase alternating current motor drive system are directed only to the case of an open-circuit fault occurring in a certain phase. In practice, the open-circuit fault may not occur only in the same phase of the motor drive system, but it may also occur in multi phases. In addition, the existing fault-tolerant control strategies for an open-circuit fault occurring in a certain phase are not applicable to the case of the open-circuit fault occurring in multiple phases of the three-phase alternating current motor drive system, resulting in a narrow range of faults to which the existing strategies are actually applicable, and a low level of reliability and safety.

### BRIEF SUMMARY

In order to solve or at least alleviate one or more of the aforementioned problems, the disclosure proposes a fault-tolerant control method and apparatus for an open-circuit fault in an alternating current motor and an inverter thereof, a computer device, and a computer storage medium. The method can be applied to the case of an open-circuit fault occurring in 1 to M phases (e.g., an open-circuit fault occurring in phase 1, . . . , an open-circuit fault occurring in phase M-1, and an open-circuit fault occurring in phase M) of an M-phase alternating current motor (M being an integer greater than or equal to 3) and an inverter thereof, which method fills the technical gap of a pure software fault-tolerant control solution for a multi-phase open-circuit fault, particularly for a multi-phase open-circuit fault in a three-phase alternating current motor drive system.

According to a first aspect of the disclosure, a fault-tolerant control method for an open-circuit fault in an alternating current motor and an inverter thereof is provided. The method includes the following steps: A: determining, based on fault information of the alternating current motor and the inverter for driving the alternating current motor, a rotor fault position interval corresponding to each fault phase in one or more fault phases; B: establishing a fault-tolerant control constraint model, where the fault-tolerant control constraint model includes an open-circuit fault equation applicable to each fault phase for the corresponding rotor fault position interval; and C: determining, with the fault-tolerant control constraint model as a constraint, a phase current reference value by using a fault-tolerant control algorithm.

As an alternative or addition to the above solution, in the method according to an embodiment of the disclosure, step A includes: A1: determining a corresponding fault state for each fault phase based on the fault information, where the fault state includes a first fault state, a second fault state, and a third fault state; and A2:

determining an open-circuit fault position interval corresponding to the fault state.

As an alternative or addition to the above solution, in the method according to an embodiment of the disclosure, step A1 includes determining the corresponding fault state for each fault phase depending on whether various phase windings of the alternating current motor are able to be connected to a positive pole and a negative pole of a power supply through the inverter; and in step A1, if the fault information indicates that when a current of a fault phase is positive, a winding in the fault phase is unable to be connected to the positive pole or the negative pole of the power supply, and that when the current of the fault phase is negative, the winding in the fault phase is able to be connected to the positive pole and the negative pole of the power supply, it is determined that the fault phase is in the first fault state; if the fault information indicates that when the current of the fault phase is negative, the winding in the fault phase is unable to be connected to the positive pole or the negative pole of the power supply, and that when the current of the fault phase is positive, the winding in the fault phase is able to be connected to the positive pole and the negative pole of the power supply, it is determined that the fault phase is in the second fault state; and if the fault information indicates that the winding in the fault phase is unable to be connected to the positive pole and the negative pole of the power supply throughout an electrical cycle, it is determined that the fault phase is in the third fault state.

As an alternative or addition to the above solution, in the method according to an embodiment of the disclosure, step A1 includes determining the corresponding fault state for each fault phase based on positions of power devices in the inverter in which the open-circuit fault occurs; and in step A1, if the fault information indicates that a power device in the inverter in which the open-circuit fault occurs is one or more of an upper bridge arm switching tube and a lower bridge arm diode in a fault phase, it is determined that the fault phase is in the first fault state; if the fault information indicates that a power device in the inverter in which the open-circuit fault occurs is one or more of a lower bridge arm switching tube and an upper bridge arm diode in the fault phase, it is determined that the fault phase is in the second fault state; and if the fault information indicates that the power devices in the inverter in which the open-circuit fault occurs satisfy one of the following conditions, it is determined that the fault phase is in the third fault state: the open-circuit fault occurring in both the upper bridge arm switching tube and the lower bridge arm switching tube in the fault phase; the open-circuit fault occurring in both the upper bridge arm diode and the lower bridge arm diode in the fault phase; the open-circuit fault occurring in both the upper bridge arm switching tube and the upper bridge arm diode in the fault phase; the open-circuit fault occurring in both the lower bridge arm switching tube and the lower bridge arm diode in the fault phase; and a total number of switching tubes and diodes in the fault phase in which the open-circuit fault occurs being more than two.

As an alternative or addition to the above solution, in the method according to an embodiment of the disclosure, step A2 includes: determining the open-circuit fault position interval corresponding to the first fault state as [π+Δθₓ, 2π+Δθₓ], determining the open-circuit fault position interval corresponding to the second fault state as [0+Δθₓ, π+Δθₓ], and determining the open-circuit fault position interval corresponding to the third fault state as [0, 2π], where

$$Δ {θ}_{x} = \frac{2 π}{M} ( x - 1 )$$

where M denotes a number of phases of the alternating current motor, x denotes a phase sequence of the fault phase, and x ≤M.

As an alternative or addition to the above solution, in the method according to an embodiment of the disclosure, in step B, the open-circuit fault equation for an x^{th} phase can be expressed as:
Fₓ(θ−Δθₓ )=0, θ ∈ an open-circuit fault position interval corresponding a fault state for the x^{th} phase,
where For denotes a fault phase current equation, and 0) denotes a motor rotor electrical angle.

As an alternative or addition to the above solution, in the method according to an embodiment of the disclosure, step C includes: C1: constructing a fault-tolerant control optimization model, where the fault-tolerant control optimization model includes a cost equation generated based on a motor torque equation, and constraints composed of one or more of the fault-tolerant control constraint model, a motor phase current limit equation, and a motor phase voltage limit equation; and C2: determining the phase current reference value by using the fault-tolerant control optimization model, where the phase current reference value is a function of the motor rotor electrical angle.

As an alternative or addition to the above solution, in the method according to an embodiment of the disclosure, if the alternating current motor is a permanent magnet synchronous motor and the inverter is a three-phase full bridge inverter, the cost equation is:

$$J = {( {T}_{ref} - \frac{3}{2} {N}_{p} {i}_{q} [ {λ}_{m} + {i}_{d} ( {L}_{d} - {L}_{q} ) ] )}^{2}$$

where T_{ref} denotes a torque reference value, Nₚ denotes a number of pole pairs of the motor, i_{d} denotes a direct-axis current, i_{q} denotes a quadrature-axis current, λₘ denotes a flux linkage of a permanent magnet, L_{d} denotes a direct-axis inductance, and L_{q} denotes a quadrature-axis inductance.

According to a second aspect of the disclosure, a fault-tolerant control apparatus for an open-circuit fault in an alternating current motor and an inverter thereof is provided. The fault-tolerant control apparatus includes: a fault determination module configured to determine, based on fault information of the alternating current motor and the inverter for driving the alternating current motor, a rotor fault position interval corresponding to each fault phase in one or more fault phases; a model establishment module configured to establish a fault-tolerant control constraint model, where the fault-tolerant control constraint model includes an open-circuit fault equation applicable to each fault phase for the corresponding rotor fault position interval; and a current determination module configured to determine, with the fault-tolerant control constraint model as a constraint, a phase current reference value by using a fault-tolerant control algorithm.

According to a third aspect of the disclosure, there is provided a computer device, which includes: a memory; a processor; and a computer program stored on the memory and executable on the processor, where the computer program is executed to enable any of the methods according to the first aspect of the disclosure to be performed.

According to a fourth aspect of the disclosure, there is provided a computer storage medium, which includes instructions, where when the instructions are run, any of the methods according to the first aspect of the disclosure is performed.

By establishing the fault-tolerant control constraint model including the open-circuit fault equations applicable to the fault phases for the corresponding rotor fault position intervals, the fault-tolerant control solution for an open-circuit fault in an alternating current motor and an inverter thereof according to the disclosure can be applicable to the case of the open-circuit fault occurring in any number of phases of the alternating current motor and the inverter thereof. In other words, the fault-tolerant control solution can be applicable to the case of the open-circuit fault occurring in 1 to M phases of the M-phase alternating current motor and the inverter thereof, which solution fills the technical gap in the art of a pure software general fault-tolerant control solution for a multi-phase open-circuit fault, particularly for a multi-phase open-circuit fault in the three-phase alternating current motor drive system. In addition, the fault-tolerant control solution can be directly applied to existing alternating current motor drive system products without changing any hardware circuit or structure of motor drive systems or increasing any additional device, thereby reducing the fault-tolerant control cost of the systems.

### BRIEF DESCRIPTION OF THE SEVERAL VIEWS OF THE DRAWINGS

The above-mentioned and/or other aspects and advantages of the disclosure will become more apparent and more readily appreciated from the following description of various aspects in conjunction with the accompanying drawings, in which the same or similar units are denoted by the same reference numerals. In the accompanying drawings:

FIG. 1 is a flowchart of a fault-tolerant control method 10 for an open-circuit fault in an alternating current motor according to one or more embodiments of the disclosure;

FIG. 2 is a diagram of a topological circuit of a three-phase full bridge inverter for driving a three-phase alternating current motor according to one or more embodiments of the disclosure;

FIG. 3 is a block diagram of a fault-tolerant control apparatus 30 for an open-circuit fault in an alternating current motor according to one or more embodiments of the disclosure; and

FIG. 4 is a block diagram of a computer device 40 according to one or more embodiments of the disclosure.

### DETAILED DESCRIPTION

The following descriptions of the specific embodiments are merely exemplary in nature, and are not intended to limit the disclosed technologies or the application and use of the disclosed technologies. In addition, there is no intention to be bound by any expressed or implied theory presented in the foregoing Technical Field and Background Art, or the following Detailed Description.

In the following detailed descriptions of the embodiments, many specific details are set forth to provide a more thorough understanding of the disclosed technologies. However, it is obvious for those of ordinary skill in the art that the disclosed technologies can be practiced without these specific details. In other instances, well-known features are not detailed, to avoid complicating the descriptions unnecessarily.

The terms such as “include” and “comprise” are used to indicate that in addition to the units and steps that are directly and clearly described in this specification, other units and steps that are not directly or clearly described are not excluded in the technical solutions of the disclosure. The terms such as “first” and “second” are not used to indicate sequences of units in terms of time, space, size, etc., and are merely used to distinguish between the units.

Various exemplary embodiments according to the disclosure will be described below in detail with reference to the accompanying drawings.

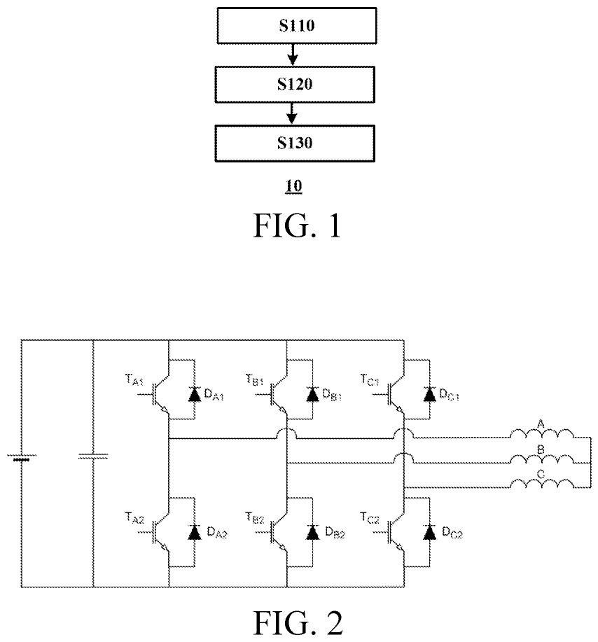

FIG. 1 is a flowchart of a fault-tolerant control method 10 for an open-circuit fault in an alternating current motor and an inverter thereof according to one or more embodiments of the disclosure. It is to be noted that the method 10 may be applicable to the case of an open-circuit fault occurring in phases 1 to M of an M-phase motor and an inverter thereof (for example, for a 3-phase motor and an inverter thereof, the method 10 may be applicable to the case of an open-circuit fault occurring in phases 1 to 3; and for another example, for a 6-phase motor and an inverter thereof, the method 10 may be applicable to the case of an open-circuit fault occurring in phases 1 to 6). In other words, the method 10 provides a general fault-tolerant control solution for either one-phase or multi-phase open-circuit fault in a multi-phase motor and an inverter thereof.

As shown in FIG. 1, in step S110, a rotor fault position interval corresponding to each fault phase in one or more fault phases is determined based on fault information of the alternating current motor and the inverter for driving the alternating current motor. Exemplarily, the above fault information may indicate whether there is an open-circuit fault in phase windings of the alternating current motor and/or in power devices (e.g., a switching tube and a diode) in the inverter for driving the alternating current motor. Exemplarily, the above fault information may also indicate whether the phase windings of the motor can be connected to a positive pole and/or a negative pole of a power supply through the inverter. It is to be noted that a diagnosis method for the fault information may be based on a diagnosis method known in the art, which is not specifically limited in the disclosure.

Exemplarily, the above alternating current motor may be a three-phase alternating current motor, such as a permanent magnet synchronous motor, an asynchronous motor, and a synchronous reluctance motor. Correspondingly, the above inverter may be a three-phase full bridge inverter commonly used in the field of motor control. The fault-tolerant control solution is explained in detail below using the three-phase alternating current motor and the three-phase full bridge inverter as an example. It is to be noted that the fault-tolerant control solution according to the disclosure can be applied to other types of alternating current motors (e.g., a five-phase alternating current motor) and other types of inverters based on the same or similar principles. The presented examples and implementations are considered to be illustrative rather than restrictive.

Optionally, in step S110, a corresponding fault state for each fault phase is first determined based on the fault information, where the fault state includes a first fault state, a second fault state, and a third fault state. Exemplarily, the fault state is associated with one or two of the following: a position of a phase winding in which the open-circuit fault occurs; a position of a power device in the inverter in which the open-circuit fault occurs; and a determination as to whether the phase windings of the motor can be connected to the positive pole and the negative pole of the power supply through the inverter.

One or more embodiments in which the corresponding fault state for each fault phase is determined based on the positions of the power devices in the inverter in which the open-circuit fault occurs is explained below. With the three-phase permanent magnet synchronous motor and the three-phase full bridge inverter as an example, if the fault information indicates that the power device in the inverter in which the open-circuit fault occurs is one or more of an upper bridge arm switching tube and a lower bridge arm diode in an x^{th} phase (x denoting a phase sequence of the fault phase, and x is a positive integer and is less than or equal to a number of phases of the motor), it is determined that the x^{th} phase is in the first fault state; if the fault information indicates that the power device in the inverter in which the open-circuit fault occurs is one or more of a lower bridge arm switching tube and an upper bridge arm diode in the x^{th} phase, it is determined that the x^{th} phase is in the second fault state; and if the fault information indicates that the power devices in the inverter in which the open-circuit fault occurs satisfy one of the following conditions, it is determined that the x^{th} phase is in the third fault state: the open-circuit fault occurring in both the upper bridge arm switching tube and the lower bridge arm switching tube in the x^{th} phase; the open-circuit fault occurring in both the upper bridge arm diode and the lower bridge arm diode in the x^{th} h phase; the open-circuit fault occurring in both the upper bridge arm switching tube and the upper bridge arm diode in the x^{th} phase; the open-circuit fault occurring in both the lower bridge arm switching tube and the lower bridge arm diode in the x^{th} phase; and a total number of switching tubes and diodes in the x^{th} phase in which the open-circuit fault occurs being more than two. The steps of determining the fault state are described below in detail in conjunction with FIG. 2.

FIG. 2 is a diagram of a topological circuit of a three-phase full bridge inverter for driving a three-phase alternating current motor according to one or more embodiments of the disclosure. As shown in FIG. 2, the three-phase full bridge inverter includes three bridge arms. Each bridge arm may be divided into an upper bridge arm and a lower bridge arm, where each of the upper bridge arm and the lower bridge arm includes one switching tube and one diode. An A-phase winding of the three-phase motor is connected to switching tubes T_{A1} and T_{A2} and diodes D_{A1} and D_{A2}, a B-phase winding of the three-phase motor is connected to switching tubes T_{B1} and T_{B2} and diodes D_{B1} and D_{B2}, and a C-phase winding of the three-phase motor is connected to switching tubes T_{C1} and T_{C2} and diodes D_{C1} and D_{C2}. As described above, if the device in which the open-circuit fault occurs is one or more of the A-phase upper bridge arm switching tube T_{A1} and the A-phase lower bridge arm diode D_{A2}, it is determined that the A-phase is in the first fault state; if the fault information indicates that the device in which the open-circuit fault occurs is one or more of the A-phase lower bridge arm switching tube T_{A2} and the A-phase upper bridge arm diode D_{A1}, it is determined that the A-phase is in the second fault state; and if the fault information indicates that power devices in which the open-circuit fault occurs satisfy one of the following conditions, it is determined that the A-phase is in the third fault state: the open-circuit fault occurring in both the switching tubes T_{A1} and T_{A2}; the open-circuit fault occurring in both the diodes D_{A1} and D_{A2}; the open-circuit fault occurring in both the switching tube T_{A1} and the diode D_{A1}; the open-circuit fault occurring in both the switching tube T_{A2} and the diode D_{A2}; and a total number of switching tubes T_{A1} and T_{A2} and diodes D_{A1} and D_{A2} in which the open-circuit fault occurs being more than two.

One or more embodiments in which the corresponding fault state for each fault phase is determined depending on whether the various phase windings of the alternating current motor can be connected to the positive pole and/or the negative pole of the power supply through the inverter. Also with the three-phase permanent magnet synchronous motor and the three-phase full bridge inverter as an example, in which a direction of a current flowing from the inverter into the motor winding is defined as positive, and a direction of a current flowing from the motor into the inverter is defined as negative, if the fault information indicates that when a current of the x^{th} phase is positive, a winding in the x^{th} phase cannot be connected to the positive pole or the negative pole of the power supply, and that when the current of the x^{th} phase is negative, the winding in the x^{th} phase can be connected to the positive pole and the negative pole of the power supply, it is determined that the x^{th} phase is in the first fault state; if the fault information indicates that when the current of the x^{th} phase is negative, the winding in the x^{th} phase cannot be connected to the positive pole or the negative pole of the power supply, and that when the current of the xth phase is positive, the winding in the x^{th} phase can be connected to the positive pole and the negative pole of the power supply, it is determined that the x^{th} phase is in the second fault state; and if the fault information indicates that the winding in the x^{th} phase cannot be connected to the positive pole and the negative pole of the power supply throughout an electrical cycle, it is determined that the x^{th} phase is in the third fault state.

With continued reference to FIG. 2, if the A-phase winding cannot be connected to the positive pole or the negative pole of the power supply when the A-phase current is positive (i_{A}>0), and if the A-phase winding can be connected to the positive pole and the negative pole of the power supply when the A-phase current is negative (i_{A}<0), it is determined that the A-phase is in the first fault state; if the A-phase winding cannot be connected to the positive pole or the negative pole of the power supply when the A-phase current is negative (i_{A}<0), and if the A-phase winding can be connected to the positive pole and the negative pole of the power supply when the A-phase current is positive (i_{A}>0), it is determined that the A-phase is in the second fault state; and if there is no rotor electrical angle in the A-phase throughout the electrical cycle, enabling the A-phase winding to be connected to the positive pole and the negative pole of the power supply, it is determined that the A-phase is in the third fault state.

Optionally, in step S110, after the corresponding fault state (e.g., the first fault state, the second fault state, and the third fault state) for each fault phase is determined, an open-circuit fault position interval corresponding to the fault state is determined. Exemplarily, the open-circuit fault position interval refers to a rotor electrical angle range within which the fault phase in the corresponding fault state cannot operate normally. Optionally, the open-circuit fault position interval corresponding to the first fault state is determined as [π+Δθₓ, 2π+Δθₓ], the open-circuit fault position interval corresponding to the second fault state is determined as [0+Δθₓ, π+Δθₓ], and the open-circuit fault position interval corresponding to the third fault state is determined as [0, 2x], where

$$Δ {θ}_{x} = \frac{2 π}{M} ( x - 1 ) \qquad ( Formula 1 )$$

where M denotes a number of phases of the alternating current motor, x denotes a phase sequence of the fault phase, and x≤M. It is to be noted that if the steps of determining the fault state in step S110 are omitted, the open-circuit fault position interval for the fault phase can be directly determined as [0, 2π], thereby simplifying the fault-tolerant control process.

It is to be understood that in the topological circuit of the three-phase full bridge inverter shown in FIG. 2, the alternating current motor has a number M of phases of 3, a phase sequence of the A-phase of 1, a phase sequence of a B-phase of 2, and a phase sequence of a C-phase of 3. In this example, if the A-phase winding cannot be connected to the positive pole or the negative pole of the power supply when the A-phase current is positive, , and if the A-phase winding can be connected to the positive pole and the negative pole of the power supply when the A-phase current is negative, the open-circuit fault position interval corresponding to the A-phase is [π, 2π]; if the A-phase winding cannot be connected to the positive pole or the negative pole of the power supply when the A-phase current is negative, , and if the A-phase winding can be connected to the positive pole and the negative pole of the power supply when the A-phase current is positive, the open-circuit fault position interval corresponding to the A-phase is [0, π]; and if there is no rotor electrical angle in the A-phase throughout the electrical cycle, enabling the A-phase winding to be connected to the positive pole and the negative pole of the power supply, the open-circuit fault position interval corresponding to the A-phase is [0, 2π]. More specifically, for the first phase (A-phase), the open-circuit fault position interval corresponding to the first fault state is [x, 2π]; the open-circuit fault position interval corresponding to the second fault state is [0, π]; and the open-circuit fault position interval corresponding to the third fault state is [0, 2π]. For the second phase (B-phase), the open-circuit fault position interval corresponding to the first fault state is [0, 2π/3] and [5π/3, 2π]; the open-circuit fault position interval corresponding to the second fault state is [2π/3, 5π/3]; and the open-circuit fault position interval corresponding to the third fault state is [0, 2π]. For the third phase (C-phase), the open-circuit fault position interval corresponding to the first fault state 1 is [π/3, 4π/3]; the open-circuit fault position interval corresponding to the second fault state is [0, π/3] and [4π/3, 2π]; and the open-circuit fault position interval corresponding to the third fault state is [0, 2π].

In step S120, a fault-tolerant control constraint model is established. The fault-tolerant control constraint model is composed of open-circuit fault equations for various fault phases, in which an open-circuit fault equation for each fault phase is applicable to its corresponding rotor fault position interval.

Exemplarily, the open-circuit fault equation may be an equation established according to a fault phase current of zero in a qd coordinate axis. Also with the three-phase permanent magnet synchronous motor and the three-phase full bridge inverter as an example, for the open-circuit fault of the first phase (A-phase), an A-phase open-circuit fault equation established in the qd coordinate axis according to the fault phase current of zero can be expressed as:

$${i}_{d} cos ( θ ) - {i}_{q} sin ( θ ) = 0 \qquad ( Formula 2 )$$

where θ denotes a motor rotor electrical angle. For the open-circuit fault of the second phase (B-phase), a B-phase open-circuit fault equation established in the qd coordinate axis according to the fault phase current of zero can be expressed as:

$${i}_{d} cos ( θ - \frac{2 π}{3} ) - {i}_{q} sin ( θ - \frac{2 π}{3} ) = 0 \qquad ( Formula 3 )$$

For the open-circuit fault of the third phase (C-phase), an open-circuit fault equation for this phase established in the qd coordinate axis according to the fault phase current of zero can be expressed as:

$${i}_{d} cos ( θ - \frac{4 π}{3} ) - {i}_{q} sin ( θ - \frac{4 π}{3} ) = 0 \qquad ( Formula 4 )$$

It is to be emphasized that the above open-circuit fault equations for various phases are applicable to the open-circuit fault position intervals corresponding to the fault states for various phases. The fault-tolerant control constraint model can be established in combination with the fault states for the phases and the open-circuit fault equations for the phases.

In an example, if the open-circuit fault occurs in all the three phases of the three-phase alternating current motor, and the first phase (A-phase) is in the first fault state, the second phase (B-phase) is in the second fault state, and the third phase (C-phase) is in the first fault state, the fault-tolerant control constraint model can be expressed as:

$$\{ \begin{matrix}{i}_{d} cos ( θ ) - {i}_{q} sin ( θ ) = 0 , & θ ∈ [ π , 2 π ] \\ {i}_{d} cos ( θ - \frac{2 π}{3} ) - {i}_{q} sin ( θ - \frac{2 π}{3} ) = 0 , & θ ∈ [ \frac{2 π}{3} , \frac{5 π}{3} ] \\ {i}_{d} cos ( θ - \frac{4 π}{3} ) - {i}_{q} sin ( θ - \frac{4 π}{3} ) = 0 , & θ ∈ [ \frac{π}{3} , \frac{4 π}{3} ]\end{matrix} \qquad ( Formula 5 )$$

In another example, if the open-circuit fault occurs in only two phases of the three-phase alternating current motor, and the first phase (A-phase) is in the second fault state, the second phase (B-phase) is in the first fault state, and the third phase (C-phase) has no fault, the fault-tolerant control constraint model can be expressed as:

$$\{ \begin{matrix}{i}_{d} cos ( θ ) - {i}_{q} sin ( θ ) = 0 , & θ ∈ [ 0 , π ] \\ {i}_{d} cos ( θ - \frac{2 π}{3} ) - {i}_{q} sin ( θ - \frac{2 π}{3} ) = 0 , & θ ∈ [ 0 , \frac{2 π}{3} ] , [ \frac{5 π}{3} , 2 π ]\end{matrix} \qquad ( Formula 6 )$$

In still another example, if the open-circuit fault occurs in only one phase of the three-phase alternating current motor, and the first phase (A-phase) has no fault, the second phase (B-phase) has no fault, and the third phase (C-phase) is in the first fault state, the fault-tolerant control constraint model can be expressed as:

$$\{ {i}_{d} cos ( θ - \frac{4 π}{3} ) - {i}_{q} sin ( θ - \frac{4 π}{3} ) = 0 , θ ∈ [ \frac{π}{3} , \frac{4 π}{3} ] \qquad ( Formula 7 )$$

The above fault-tolerant control constraint model can be simplified. For example, for the three-phase alternating current motor without a neutral wire led out, a sum of phase currents of the three phases is zero, and if currents of two phases are both zero within a certain rotor electrical angle range, the current of the third phase is also zero, and therefore, the fault-tolerant control constraint model can be simplified according to the principle.

The method for constructing the fault-tolerant control constraint model illustrated in the above example may be extended to an M-phase alternating current motor and an inverter thereof. It is to be understood that for the M-phase motor and the inverter thereof, the open-circuit fault may have a number of phases of 1 to M, and correspondingly, the fault-tolerant control constraint model is composed of 1 to M equations. Specifically, for the M-phase alternating current motor, if the open-circuit fault occurs in the x^{th} phase (x denoting the phase sequence of the fault phase, and is a positive integer and is less than or equal to M), optionally, the open-circuit fault equation for the x^{th} phase can be expressed as:

$${F}_{x} ( θ - Δ {θ}_{x} ) = 0 , θ ∈ an open - circuit fault position \\ interval corresponding to a fault state for the {x}^{th} phase \qquad ( Formula 8 )$$

where Fₓ denotes a fault phase current equation, and θ denotes a motor rotor electrical angle, the open-circuit fault position interval corresponding to the first fault state is [π+Δθₓ, 2π+Δθₓ], the open-circuit fault position interval corresponding to the second fault state is [π+Δθₓ, π+Δθₓ], and the open-circuit fault position interval corresponding to the third fault state is [0, 2π]. If the open-circuit fault occurs in phases k₁, k₂, . . . , k_{N} (N≤M), and fault states corresponding to these open-circuit fault phases are respectively s₁, s₂, . . . , s_{N} (s₁, s₂, . . . , s_{N} respectively correspond to one of the first fault state, the second fault state, and the third fault state), the fault-tolerant control constraint model for the M-phase alternating current motor can be expressed as:

$$\{ \begin{matrix}{F}_{{k}_{1}} ( θ - Δ {θ}_{{k}_{1}} ) = 0 , & θ ∈ {s}_{1} & \begin{matrix}corresponding \\ fault position interval\end{matrix} \\ {F}_{{k}_{2}} ( θ - Δ {θ}_{{k}_{2}} ) = 0 , & θ ∈ {s}_{2} & \begin{matrix}corresponding \\ fault position interval\end{matrix} \\ ⋮ & & ⋮ \\ {F}_{{k}_{N}} ( θ - Δ {θ}_{{k}_{N}} ) = 0 , & θ ∈ {s}_{N} & \begin{matrix}corresponding \\ fault position interval\end{matrix}\end{matrix} \qquad ( Formula 9 )$$

In step S130, with the fault-tolerant control constraint model as a constraint, a phase current reference value is determined by using a fault-tolerant control algorithm.

When the open-circuit fault occurs and torque control of the motor based on field-oriented control (FOC) is still selected, it is necessary to obtain a direct-axis current reference value and a quadrature-axis current reference value of the alternating current motor under fault. If a torque reference value of the motor is given as T_{ref}, and an output torque of the motor is required to be as close as possible to T_{ref} under fault, for the three-phase permanent magnet synchronous motor, a torque equation below needs to be satisfied:

$${T}_{ref} - {T}_{eq} = 0 \qquad ( Formula 10 )$$

where T_{ref} denotes the torque reference value, and T_{eq} denotes the torque equation of the alternating current motor. A fault-tolerant control optimization model can be established by combining the above torque equation and the fault-tolerant control constraint model constructed in step S120, where the fault-tolerant control optimization model includes a cost equation generated based on the motor torque equation, and constraints composed of one or more of the fault-tolerant control constraint model, a motor phase current limit equation, and a motor phase voltage limit equation. Specifically, the cost equation of the fault-tolerant control optimization model may be established based on the motor torque equation and the torque reference value:

$$J = {( {T}_{ref} - {T}_{eq} )}^{2} \qquad ( Formula 11 )$$

The constraints of the fault-tolerant control optimization model can be expressed as:

$$\{ \begin{matrix}{F}_{{k}_{1}} ( θ - Δ {θ}_{{k}_{1}} ) = 0 , & \begin{matrix}θ ∈ {s}_{1} & \begin{matrix}corresponding fault \\ position interval\end{matrix}\end{matrix} \\ {F}_{{k}_{2}} ( θ - Δ {θ}_{{k}_{2}} ) = 0 , & \begin{matrix}θ ∈ {s}_{2} & \begin{matrix}corresponding fault \\ position interval\end{matrix}\end{matrix} \\ ⋮ & \begin{matrix} & ⋮\end{matrix} \\ {F}_{{k}_{N}} ( θ - Δ {θ}_{{k}_{N}} ) = 0 , & \begin{matrix}θ ∈ {s}_{N} & \begin{matrix}corresponding fault \\ position interval\end{matrix}\end{matrix} \\ \sqrt{{i}_{d}^{2} + {i}_{q}^{2}} \leq {i}_{max} , & θ ∈ [ 0 , 2 π ] \\ \sqrt{{v}_{d}^{2} + {v}_{q}^{2}} \leq {v}_{max} , & θ ∈ [ 0 , 2 π ]\end{matrix} \qquad ( Formula 12 )$$

where v_{d} and v_{q} denote a direct-axis voltage and a quadrature-axis voltage of the alternating current motor, i_{d} and i_{q} denote a direct-axis current and a quadrature-axis current of the alternating current motor, and iₘₐₓ and Vₘₐₓ denote a maximum phase current and a maximum phase voltage of the alternating current motor. In other examples, the constraints of the fault-tolerant control optimization model may be composed only of the fault-tolerant control constraint model constructed in step S120.

Also with the three-phase permanent magnet synchronous motor and the three-phase full bridge inverter as an example, based on the motor torque equation and the torque reference value of the three-phase permanent magnet synchronous motor, the cost equation can be expressed as:

$$J = {( {T}_{ref} - \frac{3}{2} {N}_{p} {i}_{q} [ {λ}_{m} + {i}_{d} ( {L}_{d} - {L}_{q} ) ] )}^{2} \qquad ( Formula 13 )$$

where T_{ref} denotes a torque reference value, Nₚ denotes a number of pole pairs of the motor, i_{d} denotes a direct-axis current, i_{q} denotes a quadrature-axis current, λₘ denotes a flux linkage of a permanent magnet, La denotes a direct-axis inductance, and L_{q} denotes a quadrature-axis inductance. If the open-circuit fault occurs in all the three phases of the three-phase permanent magnet synchronous motor, and the first phase (A-phase) is in the third fault state, the second phase (B-phase) is in the first fault state, and the third phase (C-phase) is in the second fault state, the constraints of the fault-tolerant control optimization model in this case can be expressed as:

$$\{ \begin{matrix}{i}_{d} cos ( θ ) - {i}_{q} sin ( θ ) = 0 , & θ ∈ [ 0 , 2 π ] \\ {i}_{d} cos ( θ - \frac{2 π}{3} ) - {i}_{q} sin ( θ - \frac{2 π}{3} ) = 0 , & θ ∈ [ 0 , \frac{2 π}{3} ] , [ \frac{5 π}{3} , 2 π ] \\ {i}_{d} cos ( θ - \frac{4 π}{3} ) - {i}_{q} sin ( θ - \frac{4 π}{3} ) = 0 , & θ ∈ [ 0 , \frac{π}{3} ] , [ \frac{4 π}{3} , 2 π ] \\ \sqrt{{i}_{d}^{2} + {i}_{q}^{2}} \leq {i}_{max} , & θ ∈ [ 0 , 2 π ] \\ \sqrt{{v}_{d}^{2} + {v}_{q}^{2}} \leq {v}_{max} & θ ∈ [ 0 , 2 π ]\end{matrix} \qquad ( Formula 14 )$$

The phase current reference value of the alternating current motor under fault can be obtained by solving the fault-tolerant control optimization model. It is to be noted that due to the introduction of the fault-tolerant control constraint model into the disclosure, the obtained direct-axis current reference value and quadrature-axis current reference value are both functions of the motor rotor electrical angle.

The method 10 according to one or more embodiments of the disclosure can be applicable to the case of the open-circuit fault occurring in any number of phases of the alternating current motor and the inverter thereof. In other words, the method can be applicable to the case of the open-circuit fault occurring in 1 to M phases of the M-phase alternating current motor and the inverter thereof, which method fills the technical gap in the art of a pure software general fault-tolerant control solution for a multi-phase open-circuit fault, particularly for a multi-phase open-circuit fault in a three-phase alternating current motor drive system. In addition, the method 10 according to one or more embodiments of the disclosure can be directly applied to existing alternating current motor drive system products without changing any hardware circuit or structure of motor drive systems or increasing any additional device, thereby reducing the fault-tolerant control cost of the systems.

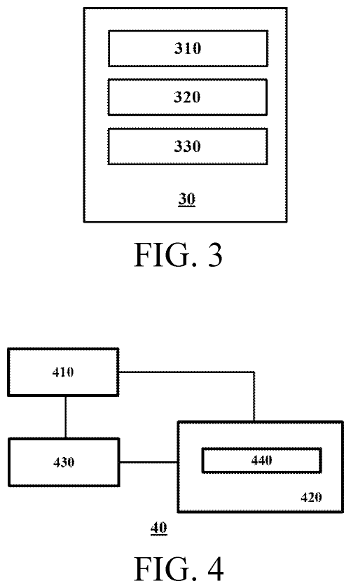

FIG. 3 is a block diagram of a fault-tolerant control apparatus 30 for an open-circuit fault in an alternating current motor and an inverter thereof according to one or more embodiments of the disclosure. It is to be noted that the fault-tolerant control apparatus 30 is applicable to the case of the open-circuit fault occurring in 1 to M phases of the M-phase motor and the inverter thereof. In other words, the fault-tolerant control apparatus 30 can perform fault-tolerant control for either one-phase or multi-phase open-circuit fault in a multi-phase motor and an inverter thereof. As shown in FIG. 3, the fault-tolerant control apparatus 30 includes a fault determination module 310, a model establishment module 320, and a current determination module 330.

The fault determination module 310 is configured to determine, based on fault information of the alternating current motor and the inverter for driving the alternating current motor, a rotor fault position interval corresponding to one or more fault phases. For the process of determining the rotor fault position interval, reference may be made to the above description of step S110, which is not repeated herein.

The model establishment module 320 is configured to establish a fault-tolerant control constraint model, where the fault-tolerant control constraint model includes an open-circuit fault equation applicable to one or more fault phases for the corresponding rotor fault position interval. For the process of establishing the fault-tolerant control constraint model, reference may be made to the above description of step S120, which is not repeated herein.

The current determination module 330 is configured to determine, with the fault-tolerant control constraint model as a constraint, a phase current reference value by using a fault-tolerant control algorithm. For the process of determining the phase current reference value, reference may be made to the above description of step $130, which is not repeated herein.

Then, referring to FIG. 4, FIG. 4 is a block diagram of a computer device 40 according to one or more embodiments of the disclosure.

As shown in FIG. 4, the computer device 40 includes a communication unit 410, a memory 420, a processor 430, and a computer program 440 stored on the memory 420 and executable on the processor 430.

The communication unit 410, as a communication interface, is configured to establish a communication connection between the computer device and an external device (e.g., a current controller and a motor sensor) or a network.

The memory 420 stores the computer program 440 executable by the processor 430. The processor 330 is configured to execute the computer program 440 to implement the method shown in FIG. 1.

According to a fourth aspect of the disclosure, there is further provided a computer-readable storage medium having a computer program stored thereon, where when the program is executed by a processor, the method 10 shown in FIG. 1 is implemented. The computer-readable storage medium may include a random access memory (RAM) such as a synchronous dynamic random access memory (SDRAM), a read-only memory (ROM), a non-volatile random access memory (NVRAM), an electrically erasable programmable read-only memory (EEPROM), a flash memory, or another known storage medium.

Various embodiments provided in the disclosure may be implemented by hardware, software, or a combination of hardware and software where applicable. In addition, without departing from the scope of the disclosure, various hardware components and/or software components described in this specification may be combined into a combined component including software, hardware, and/or both where applicable. Without departing from the scope of the disclosure, various hardware components and/or software components described in this specification may be separated into sub-components including software, hardware, or both where applicable. In addition, where applicable, it is contemplated that software components can be implemented as hardware components, and vice versa.

Software (such as program code and/or data) in the disclosure may be stored on one or more computer storage media. It is also contemplated that the software identified herein can be implemented using one or more general-purpose or special-purpose computers and/or computer systems, networked and/or otherwise. The steps described herein can be changed in order, combined into compound steps, and/or divided into sub-steps where applicable, to provide the features described herein.

The embodiments and examples proposed herein are provided to describe as adequately as possible embodiments according to the disclosure and specific applications thereof and thus enable those skilled in the art to implement and use the disclosure. However, those skilled in the art will know that the above descriptions and examples are provided only for description and illustration. The proposed description is not intended to cover all aspects of the disclosure or limit the disclosure to the disclosed precise forms.

What is claimed is:

1. A fault-tolerant control method for an open-circuit fault in an alternating current motor and an inverter thereof, the method comprising the following steps:
A: determining, based on fault information of the alternating current motor and the inverter for driving the alternating current motor, a rotor fault position interval corresponding to each fault phase in one or more fault phases;
B: establishing a fault-tolerant control constraint model, wherein the fault-tolerant control constraint model comprises an open-circuit fault equation applicable to each fault phase for the corresponding rotor fault position interval; and
C: determining, with the fault-tolerant control constraint model as a constraint, a phase current reference value by using a fault-tolerant control algorithm.

2. The method according to claim 1, wherein step A comprises:
A1: determining a corresponding fault state for each fault phase based on the fault information, wherein the fault state comprises a first fault state, a second fault state, and a third fault state; and
A2: determining an open-circuit fault position interval corresponding to the fault state.

3. The method according to claim 2, wherein step Al comprises determining the corresponding fault state for each fault phase depending on whether various phase windings of the alternating current motor are able to be connected to a positive pole and a negative pole of a power supply through the inverter; and in step A1,
if the fault information indicates that when a current of a fault phase is positive, a winding in the fault phase is unable to be connected to the positive pole or the negative pole of the power supply, and that when the current of the fault phase is negative, the winding in the fault phase is able to be connected to the positive pole and the negative pole of the power supply, it is determined that the fault phase is in the first fault state;
if the fault information indicates that when the current of the fault phase is negative, the winding in the fault phase is unable to be connected to the positive pole or the negative pole of the power supply, and that when the current of the fault phase is positive, the winding in the fault phase is able to be connected to the positive pole and the negative pole of the power supply, it is determined that the fault phase is in the second fault state; and
if the fault information indicates that the winding in the fault phase is unable to be connected to the positive pole and the negative pole of the power supply throughout an electrical cycle, it is determined that the fault phase is in the third fault state.

4. The method according to claim 2, wherein step A1 comprises determining the corresponding fault state for each fault phase based on positions of power devices in the inverter in which the open-circuit fault occurs; and in step A1, if the fault information indicates that a power device in the inverter in which the open-circuit fault occurs is one or more of an upper bridge arm switching tube and a lower bridge arm diode in a fault phase, it is determined that the fault phase is in the first fault state;
if the fault information indicates that a power device in the inverter in which the open-circuit fault occurs is one or more of a lower bridge arm switching tube and an upper bridge arm diode in the fault phase, it is determined that the fault phase is in the second fault state; and
if the fault information indicates that power devices in the inverter in which the open-circuit fault occurs satisfy one of the following conditions, it is determined that the fault phase is in the third fault state:
the open-circuit fault occurring in both the upper bridge arm switching tube and the lower bridge arm switching tube in the fault phase;
the open-circuit fault occurring in both the upper bridge arm diode and the lower bridge arm diode in the fault phase;
the open-circuit fault occurring in both the upper bridge arm switching tube and the upper bridge arm diode in the fault phase;
the open-circuit fault occurring in both the lower bridge arm switching tube and the lower bridge arm diode in the fault phase; and
a total number of switching tubes and diodes in the fault phase in which the open-circuit fault occurs being more than two.

5. The method according to claim 2, wherein step A2 comprises:
determining the open-circuit fault position interval corresponding to the first fault state as [π+Δθₓ, 2π+Δθₓ], determining the open-circuit fault position interval corresponding to the second fault state as [π+Δθₓ, π+Δθₓ], and determining the open-circuit fault position interval corresponding to the third fault state as [0, 2π],wherein
$$Δ {θ}_{x} = \frac{2 π}{M} ( x - 1 )$$
wherein M denotes a number of phases of the alternating current motor, x denotes a phase sequence of the fault phase, and x≤M.

6. The method according to claim 5, wherein in step B, the open-circuit fault equation for an x^{th} phase is able to be expressed as:
Fₓ(θ−Δθₓ)=0, θ ∈ an open-circuit fault position interval corresponding to a fault state for the x^{1″ phase,}
wherein Fₓ denotes a fault phase current equation, and 0 denotes a motor rotor electrical angle.

7. The method according to claim 1, wherein step C comprises:
C1: constructing a fault-tolerant control optimization model, wherein the fault-tolerant control optimization model comprises a cost equation generated based on a motor torque equation, and constraints composed of one or more of the fault-tolerant control constraint model, a motor phase current limit equation, and a motor phase voltage limit equation; and
C2: determining the phase current reference value by using the fault-tolerant control optimization model, wherein the phase current reference value is a function of the motor rotor electrical angle.

8. The method according to claim 7, wherein if the alternating current motor is a permanent magnet synchronous motor and the inverter is a three-phase full bridge inverter, the cost equation is:
$$J = {( {T}_{ref} - \frac{3}{2} {N}_{p} {i}_{q} [ {λ}_{m} + {i}_{d} ( {L}_{d} - {L}_{q} ) ] )}^{2}$$
wherein T_{red} denotes a torque reference value, Nₚ denotes a number of pole pairs of the motor, i_{d} denotes a direct-axis current, i_{q} denotes a quadrature-axis current, λₘ denotes a flux linkage of a permanent magnet, L_{d} denotes a direct-axis inductance, and L_{q} denotes a quadrature-axis inductance.

9. A fault-tolerant control apparatus for an open-circuit fault in an alternating current motor and an inverter thereof, the fault-tolerant control apparatus comprising:
a fault determination module configured to determine, based on fault information of the alternating current motor and the inverter for driving the alternating current motor, a rotor fault position interval corresponding to each fault phase in one or more fault phases;
a model establishment module configured to establish a fault-tolerant control constraint model, wherein the fault-tolerant control constraint model comprises an open-circuit fault equation applicable to each fault phase for the corresponding rotor fault position interval; and
a current determination module configured to determine, with the fault-tolerant control constraint model as a constraint, a phase current reference value by using a fault-tolerant control algorithm.

10. A computer device, comprising: a memory; a processor; and a computer program stored on the memory and executable on the processor, wherein the computer program is executed to enable the method according to claim 1 to be performed.

11. A computer storage medium, comprising instructions, wherein when the instructions are run, the method according to claim 1 is performed.
